(19) United States
(12) Patent Application Publication
(10) Pub. No.: US 2020/0387805 A1
(43) Pub. Date: Dec. 10, 2020

(54) PREDICTIVE DATA ANALYSIS WITH PROBABILISTIC UPDATES

(71) Applicant: Optum Services (Ireland) Limited, Dublin (IE)

(72) Inventors: Michael J. McCarthy, Dublin (IE); Kieran O'Donoghue, Dublin (IE); Harutyun Shahumyan, Dublin (IE); Neill Michael Byrne, Dublin (IE); David Lewis Frankenfield, Dublin (IE); Mohammad Karzand, Dublin (IE)

(21) Appl. No.: 16/432,535

(22) Filed: Jun. 5, 2019

(51) Int. Cl. G06N 5/02; G06N 7/00; G06N 5/04

(52) U.S. Cl. CPC G06N 5/022; G06N 5/04; G06N 7/005

(57) ABSTRACT

There is a need for solutions for more efficient predictive data analysis systems. This need can be addressed, for example, by a system configured to obtain, for each predictive task of a plurality of predictive tasks, a plurality of per-model inferences; generate, for each predictive task, a cross-model prediction based on the plurality of per-model inferences for the predictive task; and generate, based on each cross-model prediction associated with a predictive task, a cross-prediction for the particular predictive task, wherein determining the cross-prediction comprises applying one or more probabilistic updates to the cross-model prediction for the particular predictive task and each probabilistic update is determined based on the cross-model prediction for a related predictive task of the one or more related predictive tasks.

### BACKGROUND

Many existing conventional data analysis systems suffer from significant efficiency and utility drawbacks. Through ingenuity and innovation, various embodiments of the present invention make substantial improvements to the efficiency and reliability of predictive data analysis systems, including by addressing efficiency and utility drawbacks of those predictive data analysis systems.

### BRIEF SUMMARY

In general, embodiments of the present invention provide methods, apparatus, systems, computing devices, computing entities, and/or the like for predictive data analysis with probabilistic updates. Certain embodiments utilize systems, methods, and computer program products that enable cross-model prediction and cross-prediction predictive data analysis by using probabilistic updates of per-model inferences and cross-model prediction.

In accordance with one aspect, a method is provided. In one embodiment, the method is a computer-implemented method for generating a cross-prediction for a particular predictive task of a plurality of predictive tasks, wherein the plurality of predictive tasks comprises the particular predictive task and one or more related predictive tasks, and wherein the computer-implemented method comprises: obtaining, for each predictive task of the plurality of predictive tasks, a plurality of per-model inferences, wherein each per-model inference of the plurality of per-model inferences associated with a predictive task of the plurality of predictive tasks is determined based at least in part on a predictive model of a plurality of predictive models for the per-model inference; generating, for each predictive task of the plurality of predictive tasks, a cross-model prediction based at least in part on the plurality of per-model inferences for the predictive task; and generating, based at least in part on each cross-model prediction associated with a predictive task of the plurality of predictive tasks, a cross-prediction for the particular predictive task, wherein: (i) determining the cross-prediction comprises applying one or more probabilistic updates to the cross-model prediction for the particular predictive task and (ii) each probabilistic update of the one or more probabilistic updates is determined based at least in part on the cross-model prediction for a related predictive task of the one or more related predictive tasks.

In accordance with another aspect, a computer program product is provided. The computer program product may comprise at least one computer-readable storage medium having computer-readable program code portions stored therein, the computer-readable program code portions comprising executable portions configured to perform a method for generating a cross-prediction for a particular predictive task of a plurality of predictive tasks, wherein the plurality of predictive tasks comprises the particular predictive task and one or more related predictive tasks, and wherein the method comprises: obtaining, for each predictive task of the plurality of predictive tasks, a plurality of per-model inferences, wherein each per-model inference of the plurality of per-model inferences associated with a predictive task of the plurality of predictive tasks is determined based at least in part on a predictive model of a plurality of predictive models for the per-model inference; generating, for each predictive task of the plurality of predictive tasks, a cross-model prediction based at least in part on the plurality of per-model inferences for the predictive task; and generating, based at least in part on each cross-model prediction associated with a predictive task of the plurality of predictive tasks, a cross-prediction for the particular predictive task, wherein: (i) determining the cross-prediction comprises applying one or more probabilistic updates to the cross-model prediction for the particular predictive task and (ii) each probabilistic update of the one or more probabilistic updates is determined based at least in part on the cross-model prediction for a related predictive task of the one or more related predictive tasks.

In accordance with yet another aspect, an apparatus comprising at least one processor and at least one memory including computer program code is provided. In one embodiment, the at least one memory and the computer program code may be configured to, with the processor, cause the apparatus to perform a method for generating a cross-prediction for a particular predictive task of a plurality of predictive tasks, wherein the plurality of predictive tasks comprises the particular predictive task and one or more related predictive tasks, and wherein the method comprises: obtaining, for each predictive task of the plurality of predictive tasks, a plurality of per-model inferences, wherein each per-model inference of the plurality of per-model inferences associated with a predictive task of the plurality of predictive tasks is determined based at least in part on a predictive model of a plurality of predictive models for the per-model inference; generating, for each predictive task of the plurality of predictive tasks, a cross-model prediction based at least in part on the plurality of per-model inferences for the predictive task; and generating, based at least in part on each cross-model prediction associated with a predictive task of the plurality of predictive tasks, a cross-prediction for the particular predictive task, wherein: (i) determining the cross-prediction comprises applying one or more probabilistic updates to the cross-model prediction for the particular predictive task and (ii) each probabilistic update of the one or more probabilistic updates is determined based at least in part on the cross-model prediction for a related predictive task of the one or more related predictive tasks.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example external computing entity in accordance with some embodiments discussed herein.

FIG. 4 is a data flow diagram of an example process for generating cross-predictions in accordance with some embodiments discussed herein.

FIG. 5 is a flowchart diagram of an example process for generating a cross-model prediction in accordance with some embodiments discussed herein.

FIG. 6 provides an operational example of a cross-model distribution in accordance with some embodiments discussed herein.

FIG. 7 is a flowchart diagram of an example process for generating a cross-prediction in accordance with some embodiments discussed herein.

FIG. 8 provides an operational example of a cross-prediction distribution in accordance with some embodiments discussed herein.

FIG. 9 is a flowchart diagram of an example process for generating representational conclusions accordance with some embodiments discussed herein.

FIG. 10 provides an operational example of a cross-prediction visual representation in accordance with some embodiments discussed herein.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media may include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non transitory optical medium, and/or the like. Such a non-volatile computer-readable storage medium may also may include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

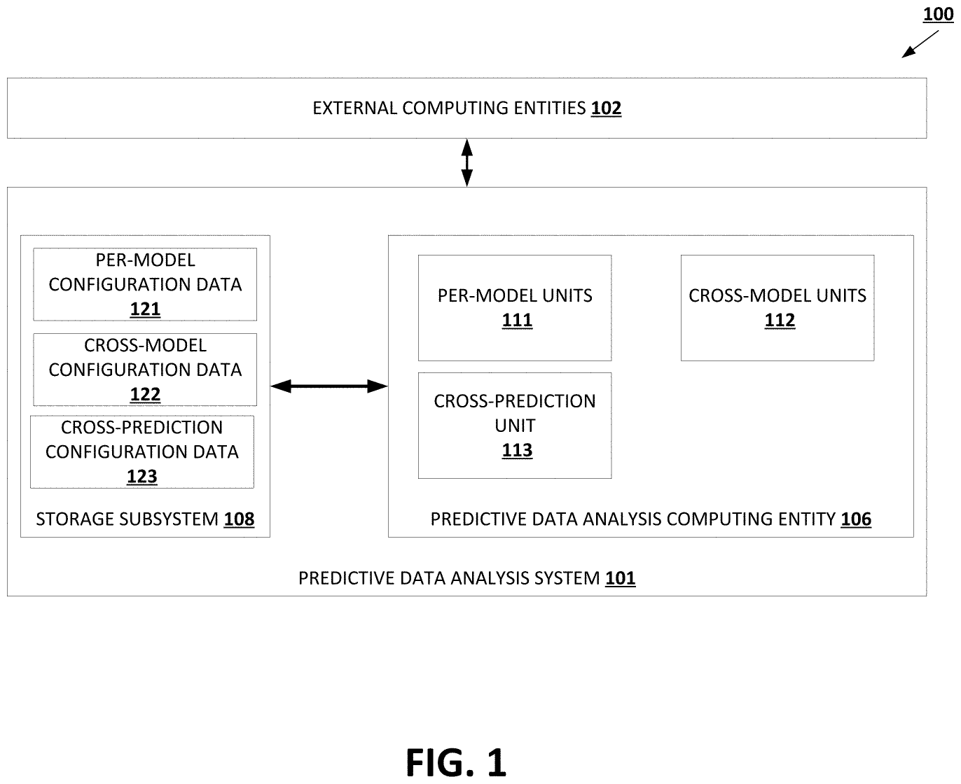

FIG. 1 provides an exemplary overview of an architecture 100 that can be used to practice embodiments of the present invention. The architecture 100 includes a predictive data analysis system 101 and one or more external computing entities 102. In some embodiments, the external computing entities 102 provide prediction inputs to the predictive data analysis system 101. The predictive data analysis system 101 generates cross-predictions based on the received prediction inputs and provides the prediction inputs to the external computing entities 102. For example, the external computing entities 102 may provide patient data to the predictive data analysis system 101, while the predictive data analysis system 101 may generate multi-morbidity cross-predictions based on the patient data and provide the generated multi-morbidity cross-predictions to the external computing entities 102. In some embodiments, the predictive data analysis system 101 interacts with the one or more external computing entities 102 over a communication network (not shown). The communication network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 includes a predictive data analysis computing entity 106 and a storage subsystem 108. The predictive data analysis computing entity 106 may be configured to generate cross-predictions based on prediction inputs by using configuration data stored in the storage subsystem 108. The predictive data analysis computing entity 106 may further be configured to generate cross-prediction visual representations based on the generated predictions. The predictive data analysis computing entity 106 may further be configured to generate representational conclusions based on the generated cross-prediction visual representations. The storage subsystem 108 may be configured to store configuration data utilized by the predictive data analysis computing entity 106 to generate cross-predictions.

The predictive data analysis computing entity 106 includes one or more per-model units 111, one or more cross-model units 112, and a cross-prediction unit 113. Each per-model unit 111 may be configured to apply a corresponding predictive model to one or more predictive inputs to generate a per-model inference for a predictive task. Each cross-model unit 112 may be configured to combine per-model inferences for a predictive task in accordance with a cross-model ensemble model for the predictive task to generate a cross-model prediction for the predictive task. The cross-prediction unit 113 may be configured to process cross-model predictions for multiple predictive tasks to generate one or more cross-predictions for each of the multiple predictive tasks.

The storage subsystem 108 stores per-model configuration data 121, cross-model configuration data 122, and cross-prediction configuration data 123. The per-model configuration data 121 may define operations and/or parameters for each predictive model utilized by at least one per-model unit 111. The cross-model configuration data 122 may define operations and/or parameters for each cross-model ensemble model utilized by at least one cross-model unit 112. The cross-prediction configuration data 123 may define operations and/or parameters utilized by the cross-prediction unit 113 to generate at least one cross-prediction based on sets of predictions (e.g., sets of cross-model predictions generated by the cross-model units 112 and based on the cross-model configuration data 122). The storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

A. Exemplary Predictive Data Analysis Computing Entity

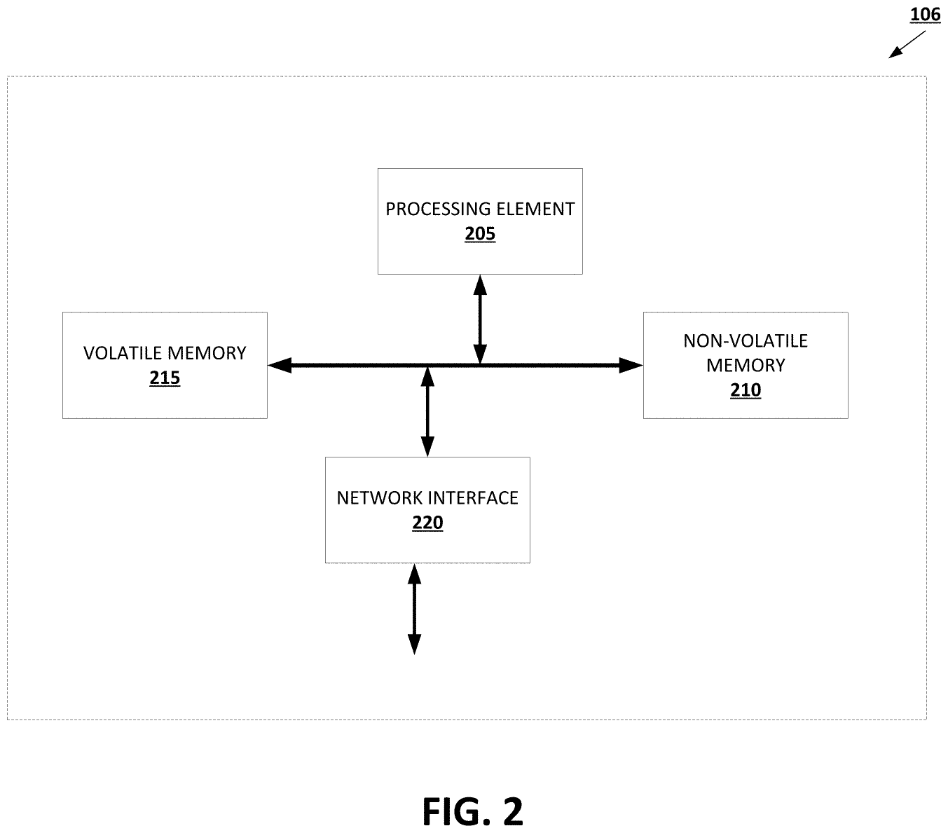

FIG. 2 provides a schematic of a Predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also may include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include or be in communication with one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further may include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FM RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further may include or be in communication with volatile media (also referred to as volatile storage, memory, memory storage, memory circuitry and/or similar terms used herein interchangeably). In one embodiment, the volatile storage or memory may also may include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also may include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include or be in communication with one or more input elements, such as a keyboard input, a mouse input, a touch screen/display input, motion input, movement input, audio input, pointing device input, joystick input, keypad input, and/or the like. The Predictive data analysis computing entity 106 may also may include or be in communication with one or more output elements (not shown), such as audio output, video output, screen/display output, motion output, movement output, and/or the like.

B. Exemplary External Computing Entity

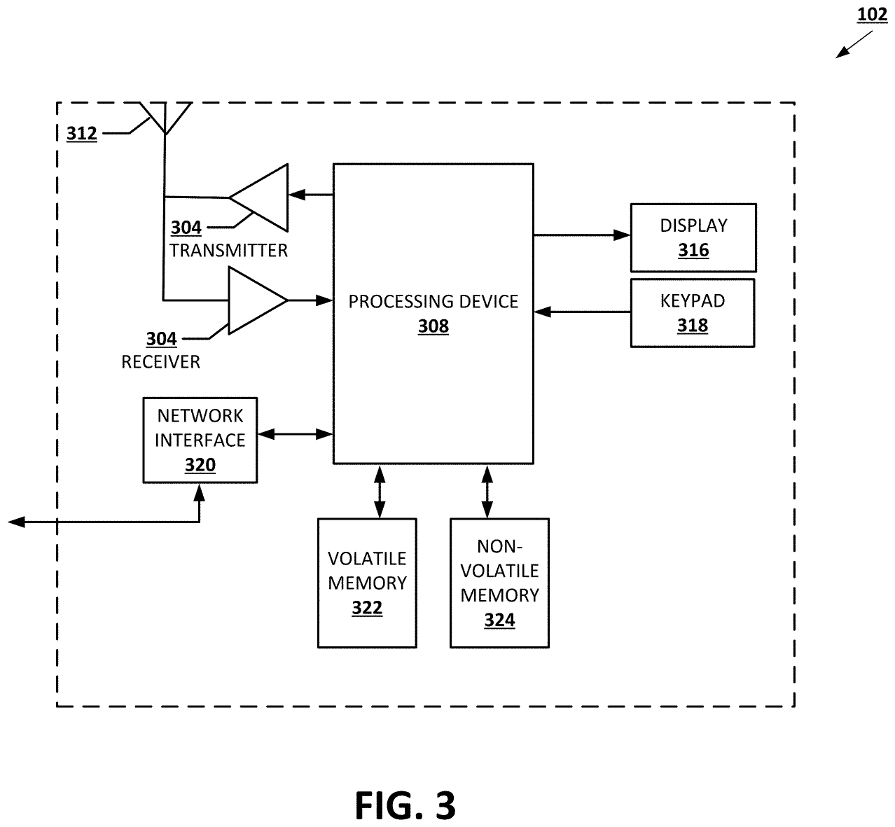

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 102 can be operated by various parties. As shown in FIG. 3, the external computing entity 102 can may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can may include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can may include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also may include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

### III. Overview

Discussed herein methods, apparatus, systems, computing devices, computing entities, and/or the like for predictive data analysis with probabilistic updates. As will be recognized, however, the disclosed concepts can be used to perform other types of data analysis.

### A. Technical Problems

Conventional predictive data analysis system suffer from considerable efficiency drawbacks resulting from multiplicity of predictive models as well as structural complexity of predictive tasks. Complex predictive input spaces are characterized by various desired predictive outputs that can each be estimated using a variety of available predictive models. This input space complexity creates considerable efficiency challenges for conventional predictive data analysis systems. Naïve approaches to addressing the noted predictive model duplicity challenges and the noted predictive task complexity challenges may lead to cross-model predictive solutions that are both computationally and storage-wise inefficient. To address such efficiency challenges, there is a technical need for predictive data analysis solutions that properly address challenges associated with managing predictive model duplicity and predictive task complexity challenges of predictive data analysis systems integrated with complex predictive input spaces.

For example, in a multi-morbidity predictive input space associated with a number of diseases, a predictive data analysis system may be tasked with discovering accurate predictions for each of the noted diseases based on outputs of various predictive models as well as based on interrelations of predictions for the various diseases. In this way, generating an accurate prediction for a particular disease (e.g., for cancer) may require combining the outputs of various cancer prediction models (e.g., a neural-network-based cancer prediction model, a Bayesian-network-based cancer prediction model, a decision-tree-based cancer prediction model, etc.) and the predictions for various other diseases (e.g., an Alzheimer's disease prediction, a Crone's disease prediction, etc.). Accordingly, multi-morbidity predictive input spaces are examples of complex predictive input spaces that pose efficiency challenges for predictive data analysis systems in terms of multiplicity of predictive models as well as structural complexity of predictive tasks.

Furthermore, conventional predictive data analysis systems fail to provide predictive-model-integration solutions that are sufficiently interpretable. For example, existing ensemble learning techniques for combining heterogeneous predictive models, such as stacking, often generate meta-models that are not sufficiently interpretable. In the multi-morbidity space, this leads to cross-disease inferences that are do not provide meaningful insights to users of predictive data analysis systems, such as to subject matter expert users of the noted predictive data analysis systems. In this way, lack of sufficient interpretability of predictive-model-integration solutions in predictive data analysis systems can undermine the utility of such systems for a variety of use cases and for a variety of users. Thus, many conventional predictive data analysis systems suffer from utility challenges because they fail to provide predictive-model-integration solutions that are sufficiently interpretable.

### B. Technical Solutions

Various embodiments of the present invention address technical challenges related to efficiency of predictive data analysis systems by using cross-prediction-generation solutions that utilize probabilistic updates. In some embodiments, multiple per-model inferences generated by applying a predictive model in relation to a predictive task are aggregated in accordance with a cross-model ensemble model to generate a cross-model prediction for the predictive task. In some of those embodiments, various cross-model predictions for various predictive tasks are then aggregated to generate cross-predictions for predictive tasks. Such an arrangement of per-model units, cross-model units, and cross-predictions provides efficient techniques for addressing predictive model duplicity and predictive task complexity challenges of complex predictive input spaces. In this way, various embodiments of the present invention address efficiency drawbacks resulting from failure of conventional predictive data analysis systems to respond to challenges associated with multiplicity of predictive models as well as structural complexity of predictive tasks.

For example, in the multi-morbidity predictive input space, various embodiments of the present invention describe a step-by-step method for the problem of aggregating the output of multiple disease prediction models by creating a multidimensional representation of a patients' morbidity. This representation gives insight into the structure and density of morbidity space, a concept that captures how diseases co-vary and how patients cluster within the modelled disease spectrum. In some embodiments, each patient that is fed through the disease prediction framework generates a point in morbidity space that can be thought of as their risk profile. Thus, patients that cluster together in morbidity space have similar risk profiles, an insight that is useful in detecting undiagnosed conditions. Moreover, various embodiments of the present invention project additional information onto this morbidity space to help understand, for example, which disease areas are the costliest or the most debilitating. Studying how patients move through morbidity space through time could provide insights into how morbidities and multi-morbidities develop and what could be done to mitigate them. The multidimensional representation described by various embodiments of the present invention also facilitates the analysis, via Bayesian updating, of how and when the models reinforce and attenuate each other. For example, the likelihood of the existence of a certain combination of conditions given the multidimensional output can be decomposed into multiplicative terms that capture the interrelationships and co-dependencies of each model and isolate the marginal impact of either a particular model output or the additional information of the existence of another condition.

Moreover, various embodiments of the present invention address utility challenges associated with conventional predictive data analysis systems that stem from insufficient interpretability of inner workings of such systems. For example, various embodiments of the present invention provide innovative solutions for the problem of aggregating the output of multiple disease prediction models, each trained on a given condition, to obtain a multidimensional representation of patients' morbidity across the spectrum of modelled diseases. The resulting disease prediction framework will not look at diseases one-by-one but instead develops a holistic view of patients' entire morbidity. Understanding how these diseases co-vary, how and when patients develop comorbid conditions, and how to cluster patient conditions into distinct groups requires a multidimensional view on morbidity. In addition, various embodiments of the present invention provide innovative solutions for the problem of creating an ensemble of heterogeneous base models without training a meta-model, thus achieving high performance while preserving model interpretability. Existing ensemble learning techniques for combining heterogeneous models, such as stacking, achieve high predictive model performance but the multiple layers of models can make the meta-model impossible to interpret. In the context of disease prediction, the proposed solutions cover not just combining the outputs from multiple models predicting different diseases but also combining the outputs from multiple heterogeneous models predicting the same disease. In other words, the approach can create a composite single disease score using multiple models predicting that particular disease and then combine these composite disease scores into a multidimensional morbidity representation. In this way, various embodiments of the present invention address utility challenges associated with conventional predictive data analysis systems that stem from insufficient interpretability of inner workings of such systems.

### C. Definitions of Certain Terms

The term “predictive task” refers to determining a likelihood of occurrence of one or more conditions, such as one or more real-world entities and/or one or more real-world properties, with respect to particular prediction inputs. Examples of predictive tasks include cancer prediction for patients and based on patient data, Alzheimer's disease prediction for patients and based on patient data, Crohn's disease prediction for patients and based on patient data, prediction of cancer-plus-Alzheimer's-disease for patients and based on patient data, prediction of cancer-minus-Alzheimer's-disease for patients and based on patient data, etc.

The term “per-model inference” for a predictive task refers to data generated by applying a predictive model to a predictive input for the predictive task, where the data indicates a value for the likelihood of occurrence characterizing the predictive task. For example, a particular per-model inference may be generated by applying a neural network predictive model to a predictive input for a cancer prediction predictive task.

The term “cross-model prediction” for a predictive task refers to data generated by combining one or more per-model inferences associated with a predictive task, where the data indicate a value for the likelihood of occurrence characterizing the predictive task. For example, a particular cross-model prediction for a cancer prediction predictive task may be generated by combining the following per-model inferences: a per-model inference for the cancer prediction predictive task generated based on a neural network predictive model, a per-model inference for the cancer prediction predictive task generated based on a Bayesian network predictive model, and a per-model inference for the cancer prediction predictive task generated based on a decision tree predictive model. A cross-model prediction for a predictive task may be determined based on a cross-model ensemble model for the predictive task.

The term “cross-model ensemble model” refers to data describing operations and/or parameters utilized to combine one or more per-model inferences to generate a cross-model prediction. For example, in accordance with a particular cross-model ensemble model, each per-model inference of one or more per-model inferences is transformed in accordance with a cross-model ensemble parameter to generate a transformed per-model inference and the transformed per-model inferences are then combined to generate a cross-model prediction.

The term “cross prediction” for a particular predictive task refers to data generated by combining two or more predictions (e.g., including one or more cross-model predictions), where the two or more predictions include a prediction for the particular predictive task and one or more related predictions each associated with a predictive task other than the particular predictive task. For example, a cross-prediction for a cancer predictive task may indicate a prediction about a likelihood of occurrence of cancer in a patient given a likelihood of occurrence of Alzheimer's disease. As another example, a cross-prediction for a cancer-plus-Crohn's-disease predictive task may indicate a prediction about a likelihood of occurrence of cancer in a patient given a likelihood of occurrence of Alzheimer's disease in the patient. As a further example, a cross-prediction for a cancer predictive task may indicate a prediction about a likelihood of occurrence of cancer in a patient given a per-model inference associated with occurrence of cancer in the patient based on a predictive model and a cross-model prediction associated with occurrence of Alzheimer's disease in the patient.

### IV. Exemplary System Operation

Various embodiments of the present invention address technical challenges related to efficiency of predictive data analysis systems by using cross-prediction-generation solutions that utilize probabilistic updates. In some embodiments, multiple per-model inferences generated by applying a predictive model in relation to a predictive task are aggregated in accordance with a cross-model ensemble model to generate a cross-model prediction for the predictive task. In some of those embodiments, various cross-model predictions for various predictive tasks are then aggregated to generate cross-predictions for predictive tasks. Such an arrangement of per-model units, cross-model units, and cross-predictions provides efficient techniques for addressing predictive model duplicity and predictive task complexity challenges of complex predictive input spaces. In this way, various embodiments of the present invention address efficiency drawbacks resulting from failure of conventional predictive data analysis systems to respond to challenges associated with multiplicity of predictive models as well as structural complexity of predictive tasks.

### Generating Cross-Predictions

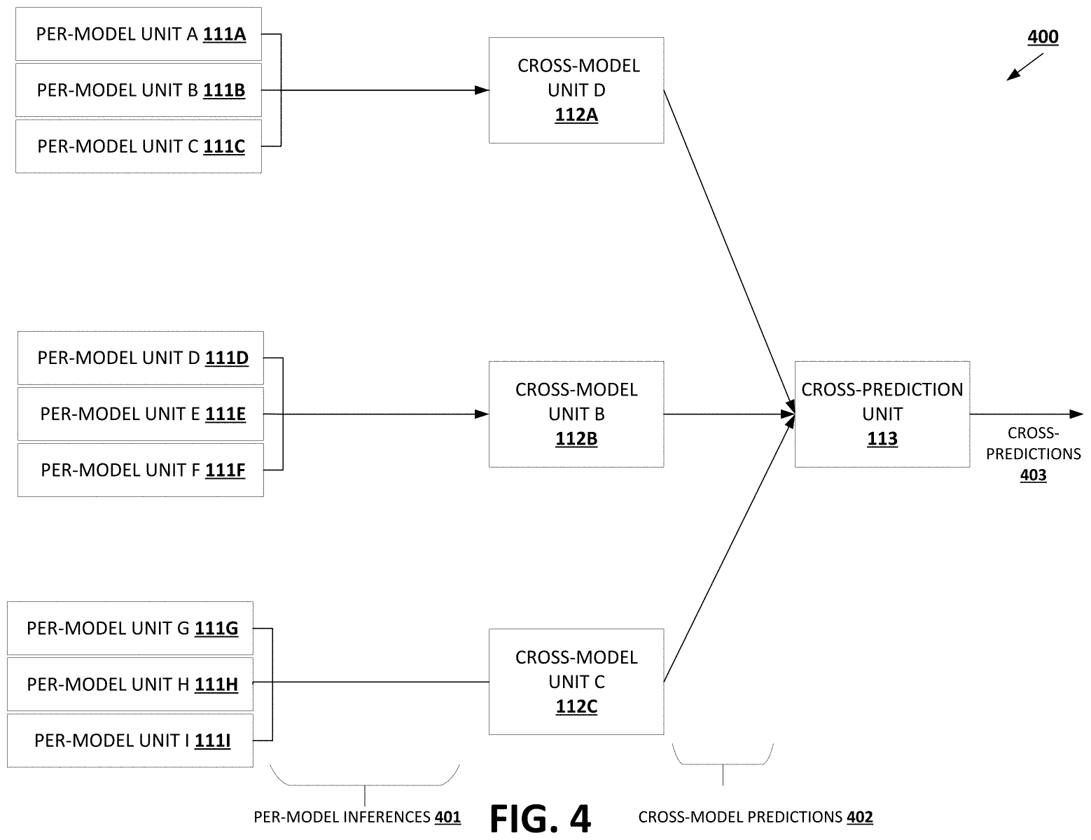

FIG. 4 is a data flow diagram of an example process 400 for generating one or more cross-predictions 403 each corresponding to a predictive task. Through the various steps/operations of process 400, a system of one or more computers can generate cross-predictions by using cross-prediction probabilistic updating (e.g., Bayesian probabilistic updating). Process 400 will now be described with reference to the predictive data analysis computing entity 106 of FIG. 1.

As depicted in FIG. 4, the process 400 begins when each per-model units 111A-I of the predictive data analysis computing entity 106 generates a per-model inference 401 for a corresponding predictive task associated with the per-model unit 111A-I by applying a corresponding predictive model associated with the per-model unit 111A-I to one or more predictive inputs. In some embodiments, a particular per-model unit 111A-I is configured to: (i) obtain (e.g., from an external computing entity 102) one or more predictive inputs for the particular per-model unit 111A-I (e.g., patient data associated with a particular patient); (ii) obtain (e.g., from the per-model configuration data 121 stored in the storage subsystem 108) a particular predictive model (e.g., a neural network predictive model) associated with the particular per-model unit 111A-I; and (iii) apply the particular predictive model to the one or more predictive inputs to generate a per-model inference 401 (e.g., a neural network cancer disease prediction) for a predictive task (e.g., a cancer prediction predictive task).

For example, as depicted in FIG. 4, each of the per-model units 111A-C may be configured to apply a corresponding predictive model to one or more predictive inputs to generate a per-model inference 401 associated with a cancer prediction predictive task. As another example, each of the per-model units 111D-E may be configured to apply a corresponding predictive model to one or more predictive inputs to generate a per-model inference 401 associated with an Alzheimer's disease prediction predictive task. As yet another example, each of the per-model units 111G-I may be configured to apply a corresponding predictive model to one or more predictive inputs to generate a per-model inference 401 associated with Crohn's disease prediction predictive task.

While not depicted in FIG. 4, a person of ordinary skill in the art will recognize that at least some of the per-model units 111A-I may be associated with the same predictive model. For example, each of the per-model units A 111A, D 111D, and G 111G may be associated with a particular neural network predictive model, where the per-model unit A 111A is configured to apply the particular neural network predictive model to one or more predictive inputs to generate a per-model inference 401 associated with a cancer prediction predictive task, the per-model unit D 111D is configured to apply the particular neural network predictive model to one or more predictive inputs to generate a per-model inference 401 associated with an Alzheimer's disease predictive task, and the per-model unit G 111G is configured to apply the particular neural network predictive model to one or more predictive inputs to generate a per-model inference 401 associated with a Crohn's disease predictive task. As another example, each of the per-model units B 111B, E 111E, and H 111H may be associated with a particular Bayesian network predictive model, where the per-model unit B 111B is configured to apply the particular Bayesian network predictive model to one or more predictive inputs to generate a per-model inference 401 associated with a cancer prediction predictive task, the per-model unit E 111E is configured to apply the particular Bayesian network predictive model to one or more predictive inputs to generate a per-model inference 401 associated with an Alzheimer's disease predictive task, and the per-model unit H 111H is configured to apply the particular Bayesian network predictive model to one or more predictive inputs to generate a per-model inference 401 associated with a Crohn's disease predictive task. As a further example, each of the per-model units C 111C, F 111F, and I 111I may be associated with a particular decision tree predictive model, where the per-model unit C 111C is configured to apply the particular decision tree predictive model to one or more predictive inputs to generate a per-model inference 401 associated with a cancer prediction predictive task, the per-model unit F 111F is configured to apply the particular decision tree predictive model to one or more predictive inputs to generate a per-model inference 401 associated with an Alzheimer's disease predictive task, and the per-model unit I 111I is configured to apply the particular decision tree predictive model to one or more predictive inputs to generate a per-model inference 401 associated with a Crohn's disease predictive task.

The process 400 continues when each per-model unit 111A-I provides its generated per-model inference 401 to a cross-model unit 112A-C associated with the per-model unit 111A-I. In particular, the per-model units A-C 111A-C provide their generated per-model inferences 401 to the cross-model unit A 112A, the per-model units D-F 111D-F provide their generated per-model inferences 401 to the cross-model unit B 112B, and the per-model units G-I 111G-I provide their generated per-model inferences 401 to the cross-model unit C 112C. In some embodiments, a particular cross-model unit 112A-C is configured: (i) obtain (e.g., from the per-model units 111A-I) particular per-model inferences 401 for a particular predictive task associated with the particular cross-model unit 112A-C, (ii) obtain (e.g., from the cross-model configuration data 122 stored in the storage subsystem 108) a particular cross-model ensemble model associated with the particular predictive task, and (iii) apply the particular cross-model ensemble model to the particular per-model inferences 401 for the particular predictive task to generate a cross-model prediction 402 for the particular predictive task.

In some embodiments, each cross-model unit 112A-C is associated with a corresponding predictive task and is configured to process one or more per-model inferences associated with the corresponding predictive task to generate a cross-model prediction 402 for the corresponding predictive task. For example, the cross-model unit A 112A may be associated with a cancer prediction predictive task and may be configured to process per-model inferences 401 associated with the cancer prediction predictive task (e.g., per-model inferences 401 generated by the per-model units A-C 111A-C) to generate a cross-model prediction 402 for the cancer prediction predictive task. As another example, the cross-model unit B 112B may be associated with an Alzheimer's disease prediction predictive task and may be configured to process per-model inferences 401 associated with the cancer prediction predictive task (e.g., per-model inferences 401 generated by the per-model units D-F 111D-F) to generate a cross-model prediction 402 for the Alzheimer's disease prediction predictive task. As a further example, the cross-model unit C 112C may be associated with a Crohn's disease prediction predictive task and may be configured to process per-model inferences 401 associated with the Crohn's disease prediction predictive task (e.g., per-model inferences 401 generated by the per-model units G-I 111G-I) to generate a cross-model prediction 402 for the Crohn's disease prediction predictive task.

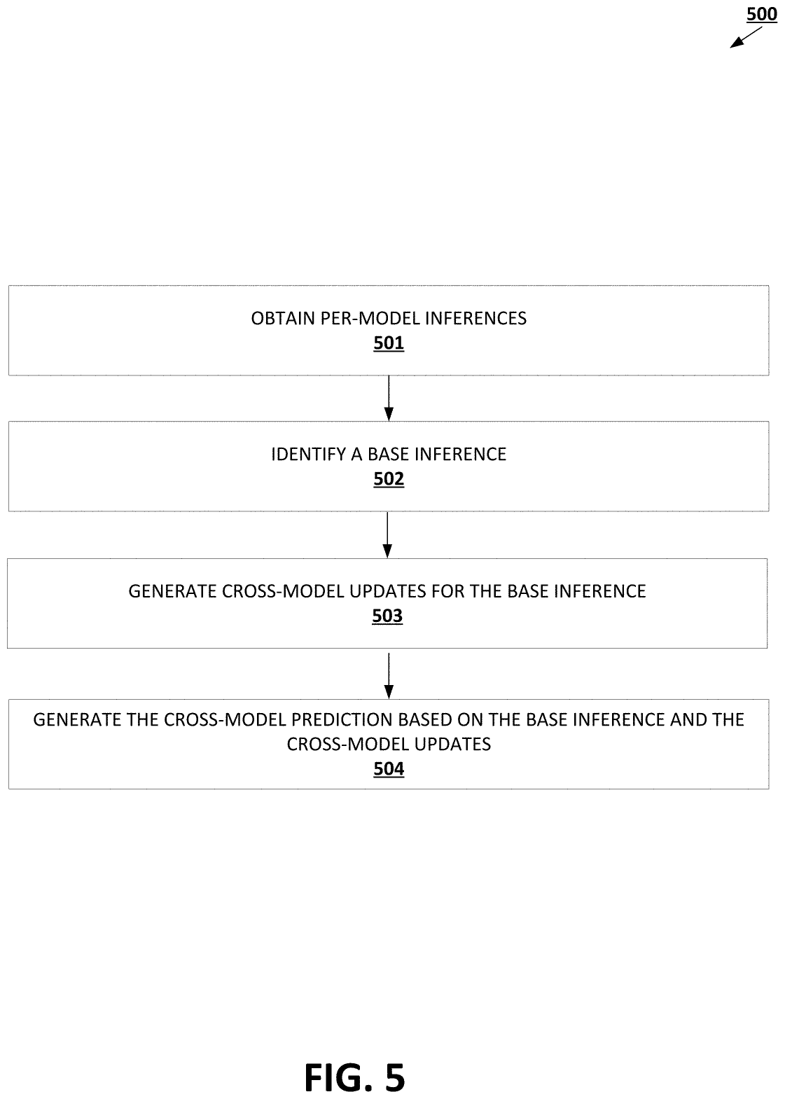

In some embodiments, to generate a particular cross-model prediction 402 for a particular predictive task, a particular cross-model unit 112A-C may perform the various steps/operations of the example process 500 depicted in FIG. 5. The process 500 begins at step/operation 501 when the particular cross-model unit 112A-C obtains particular per-model inferences 401 for the particular predictive task. For example, the particular cross-model unit 112A-C may obtain a particular per-model inference 401 associated with the particular predictive task that is generated by a per-model unit 111A-I for a neural network predictive model, a particular per-model inference 401 associated with the particular predictive task that is generated by a per-model unit 111A-I for a Bayesian network predictive model, a particular per-model inference 401 associated with the particular predictive task that is generated by a per-model unit 111A-I for a decision tree network predictive model, a particular per-model inference 401 associated with the particular predictive task that is generated by a per-model unit 111A-I for a random forest network predictive model, etc. A particular per-model inference 401 may correspond to a probability value characterized by P(Dₘ|mₙ), where Dₘ is the particular predictive task for the particular per-model inference and mₙ is an output of a particular predictive model associated with the particular per-model inference.

At step/operation 502, the particular cross-model unit 112A-C identifies a base inference from the particular per-model inferences 401 obtained in step/operation 501. For example, the particular cross-model unit 112A-C may identify a particular per-model inference 401 generated based on a default predictive model for the particular predictive task as the base inference for the particular predictive task. In another example, the particular cross-model unit 112A-C may identify a randomly-selected per-model inference 401 as the base inference for the particular predictive task.

At step/operation 503, the particular cross-model unit 112A-C generates one or more cross-model updates for the base inference. In some embodiments, the particular cross-model unit 112A-C generates a cross-model order for the particular per-model inferences 401 obtained in step/operation 501, where the cross-model order identifies a cross-model degree for each particular per-model inference 401 including a lowest cross-model degree for the base inference. Then, for each first particular per-model inference 401 other than the base inference which has a corresponding first cross-model degree in the cross-model order, the particular cross-model unit 112A-C generates a first cross-model update that relates a partial cross-model prediction 402 determined based on the base inference and based on each particular per-model inference 401 having a lower cross-model degree than the first cross-model degree to a final cross-model prediction 402 based on the first particular per-model inference 401. For example, given a set of per-model inferences 401 {IN₁, IN₂, IN₃, IN₄} having the cross-model order {IN₁→IN₂→IN₃→IN₄} where IN₁ is the base inference, the particular cross-model unit 112A-C may generate a first cross-model update that relates IN₁ to the final cross-model prediction 402 based on IN₂, a second cross-model update that relates the first cross-model update to the final cross-model prediction 402 based on IN₃, and a third cross-model update that relates the second cross-model update to the final cross-model prediction 402 based on IN₄.

At step/operation 504, the particular cross-model unit 112A-C generates the cross-model prediction 402 based on the base inference identified in step/operation 502 and the one or more cross-model updates generated in step/operation 503. For example, the particular cross-model unit 112A-C may generate a cross-model prediction 402 P(D₁|m₁, m₂) for a predictive task D₁ based on the per-model inferences 401 P(D₁|m₁) and P(D₁|m₂) by performing steps/operations corresponding to the equation:

$$P ( {D}_{1} \vert {m}_{1} , {m}_{2} ) = \frac{P ( {m}_{2} \vert {D}_{1} ⋂ {m}_{1} )}{P ( {m}_{2} \vert {m}_{1} )} * P ( {D}_{1} \vert {m}_{1} ) ,$$

where the latter term is the base inference, the former term is the cross-model update for the non-base inference P(D₁|m₂), and m₁ and m₂ are outputs of particular predictive models associated with the per-model inferences P(D₁|m₁)−P(D₂|m₂) respectively. As another example, the particular cross-model unit 112A-C may generate a cross-model prediction 402 P(D₁∥m₁, m₂, m₃) for a predictive task D₁ based on the per-model inferences 401 P(D₁|m₁), P(D₁|m₂), and P(D₁|m₃) by performing steps/operations corresponding to the equation:

$$P ( D 1 \vert m 1 , m 2 , m 3 ) = \frac{P ( {m}_{3} \vert {D}_{1} ⋂ {m}_{1} ⋂ {m}_{2} )}{P ( {m}_{3} \vert {m}_{1} ⋂ {m}_{2} )} * \frac{P ( {m}_{2} \vert {D}_{1} ⋂ {m}_{1} )}{P ( {m}_{2} \vert {m}_{1} )} * P ( {D}_{1} \vert {m}_{1} ) ,$$

where the latter term is the base inference, the former two terms are the cross-model updates for the non-base inference P(D₁|m₃) and P(D₁|m₂) respectively, and m₁-m₃ are outputs of particular predictive models associated with the per-model inferences P(D₁|m₁)−P(D₂|m₃) respectively.

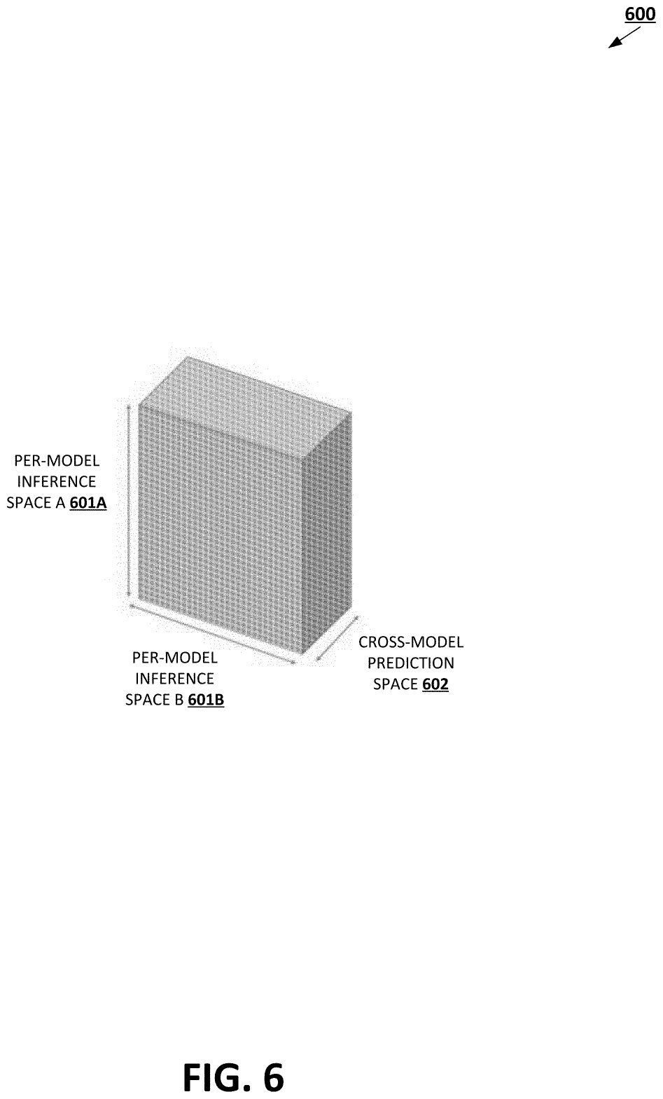

In some embodiments, the per-model inferences 401 and the cross-model updates are determined based on a cross-model distribution, such as the cross-model distribution 600 of FIG. 6. The cross-model distribution 600 is associated with two per-model inferences, i.e., a per-model inference A whose range is represented by the per-model inference space A 601A and a per-model inference B whose range is represented by the per-model inference space B 601B. The cross-model distribution 600 also includes a third dimension associated with the cross-model prediction space 602, which indicates a cross-model prediction for each combination of a particular value for the per-model inference A and a particular value for the per-model inference B. In some embodiments, a cross-model distribution such as the cross-model distribution 600 is stored on the storage subsystem 108 as part of the cross-model configuration data 122.

Returning to FIG. 4, the process 400 continues when the cross-prediction unit 113 obtains the cross-model predictions 402 to generate one or more cross-predictions 403. A cross-prediction 403 may be a prediction for a first predictive task given a prediction (e.g., a cross-model prediction 402) for each of one or more other predictive tasks. In some embodiments, the cross-predictions 403 include one or more multi-morbidity predictions, i.e., a prediction about presence of one or more diseases (e.g., a single disease and/or a combination of diseases) given one or more related disease predictions, wherein each related disease prediction is about presence of one or more related diseases (e.g., a single related disease and/or a combination of related diseases). Examples of multi-morbidity predictions may include a prediction for a cancer prediction predictive task given a prediction for an Alzheimer's disease prediction predictive task and/or a prediction for a Crohn's disease prediction predictive task; a prediction for an Alzheimer's disease prediction predictive task given a prediction for a cancer disease prediction predictive task and/or a Crohn's disease prediction predictive task; a prediction for a Crohn's disease prediction predictive task given a prediction for a cancer disease prediction predictive task and/or an Alzheimer's disease prediction predictive task; a prediction for a prediction task associated with presence of both cancer and Alzheimer's disease given a prediction for a Crohn's disease prediction predictive task and/or a leukemia prediction predictive task; etc.

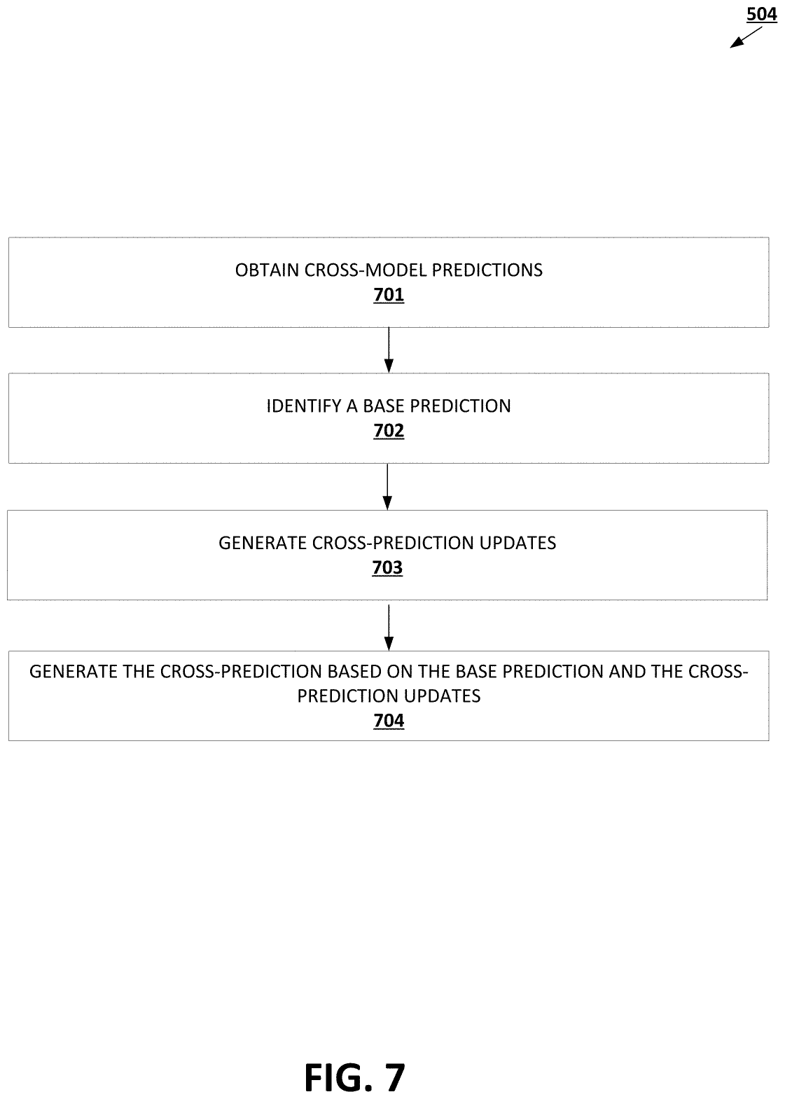

In some embodiments, to generate a particular cross-prediction 403 for a particular predictive task, the cross-prediction unit 113 may perform the various steps/operations of the process depicted in FIG. 7. The process depicted in FIG. 7 begins at step/operation 701 when the cross-prediction unit 113 obtains cross-model predictions 402 for multiple predictive tasks. For example, the cross-prediction unit 113 may obtain a first cross-model prediction associated with a cancer prediction predictive task, a second cross-model prediction associated with an Alzheimer's disease prediction predictive task, a third cross-model prediction associated with a Crohn's disease prediction predictive task, etc. A cross-model prediction 402 for a particular predictive task may correspond to a probability value characterized by P(D₁|m₁ . . . mₙ), where D₁ corresponds to the particular predictive task, m₁ . . . mₙ correspond to outputs of particular predictive models, and n may be two or more.

At step/operation 702, the cross-prediction unit 113 identifies a base prediction from the cross-model predictions 402 obtained in step/operation 701. For example, where the particular cross-model prediction 402 is associated with a particular predictive task, the cross-prediction unit 113 may identify the cross-model prediction 402 associated with the particular predictive task as the base prediction from the cross-model predictions 402.

At step/operation 703, the cross-prediction unit 113 generates one or more cross-prediction updates for the base prediction. In some embodiments, the particular cross-model unit 112A-C generates a cross-prediction order for the cross-model predictions 402 obtained in step/operation 701, where the cross-prediction order identifies a cross-prediction degree for each particular cross-model prediction 402 including a lowest cross-model degree for the base prediction. Then, for each cross-model prediction 402 other than the base prediction which has a corresponding first cross-prediction degree in the cross-prediction order, the particular cross-model unit 112A-C generates a first cross-prediction update that relates a partial cross-prediction 403 determined based on the base prediction and based on each cross-model prediction 402 having a lower cross-prediction degree than the first cross-prediction degree to a final cross-prediction 403 based on the first cross-model prediction 402. For example, given a set of cross-model prediction 402 {CP₁, CP₂, CP₃, CP₄} having the cross-prediction order {CP₁→CP₂→CP₃→CP₄} where CP₄ is the base prediction, the cross-prediction unit 113 may generate a first cross-prediction update that relates CP₁ to the final cross-prediction 403 based on CP₂, a second cross-prediction update that relates the first cross-prediction update to final cross-prediction 403 based on CP₃, and a third cross-prediction update that relates the second cross-prediction update to the final cross-prediction 403 based on CP₄.

At step/operation 504, the cross-prediction unit 113C generates the cross-prediction 403 based on the base prediction identified in step/operation 702 and the one or more cross-prediction updates generated in step/operation 703. For example, the cross-prediction unit 113C may generate a cross prediction 403 P(D₁|m₁, m₂, D₂) for a predictive task D1 based on the per-model inferences 401 P(D₁|m₁) and P(D₂|m₂), the cross-model prediction 402 P(D₁|m₁, m₂), and a cross-model prediction 402 for the predictive task D₂ by performing steps/operations corresponding to the equation:

$$P ( {D}_{1} \vert {m}_{1} , {m}_{2} , {D}_{2} ) = \frac{P ( {D}_{2} \vert {D}_{1} ⋂ {m}_{1} ⋂ {m}_{2} )}{P ( {D}_{2} \vert {m}_{1} ⋂ {m}_{2} )} * P ( {D}_{1} \vert {m}_{1} , m 2 ) ,$$

where the latter term is the base prediction, the former term is the cross-prediction update corresponding to the predictive task D₂, and m₁ and m₂ are outputs of particular predictive models associated with the predictive task D₁. As another example, the cross-prediction unit 113C may generate a cross prediction 403 P(D₁|m₁, m₂, D₂, D₃) for a predictive task D₁ based on the per-model inferences 401 P(D₁|m₁) and P(D₂|m₂), the cross-model prediction 402 P(D₁|m₁, m₂), a cross-model prediction 402 for the predictive task D2, and a cross-model prediction 402 for the predictive task D3 by performing steps/operations corresponding to the equation:

$$P ( D 1 \vert m 1 , m 2 , D 2 , D 3 ) = \frac{P ( {D}_{3} \vert {D}_{1} ⋂ {m}_{1} ⋂ {m}_{2} ⋂ {D}_{2} )}{P ( {D}_{3} \vert {m}_{1} ⋂ {m}_{2} ⋂ {D}_{2} )} * \frac{P ( {D}_{2} \vert {D}_{1} ⋂ {m}_{1} ⋂ {m}_{2} )}{P ( {D}_{2} \vert {m}_{1} ⋂ {m}_{2} )} * P ( {D}_{1} \vert {m}_{1} , m 2 ) ,$$

where the latter term is the base prediction, the former two terms are the cross-prediction updates corresponding to the predictive tasks D2 and D3, and m1 and m2 are outputs of particular predictive models associated with the predictive task D1. As a further example, the cross-prediction unit 113C generates the cross-prediction 403 P[W|(S_{D}_{₁}∩S_{D}_{₂}∩S_{D}_{₃})], which describes the probability of event W given three disease scores S_{D}_{₁}, S_{D}_{₂}, and S_{D}_{₃} by performing steps/operations corresponding to the equation:

$$P [ W \vert ( {S}_{{D}_{1}} ⋂ {S}_{{D}_{2}} ⋂ {S}_{{D}_{3}} ) ] = \frac{ [ {S}_{{D}_{3}} \vert ( W ⋂ {S}_{{D}_{1}} ⋂ {S}_{{D}_{2}} ) ]}{ [ {S}_{{D}_{3}} \vert ( {S}_{{D}_{1}} ⋂ {S}_{{D}_{2}} ) ]} \cdot \frac{ [ {S}_{{D}_{2}} \vert ( W ⋂ {S}_{{D}_{1}} ) ]}{ [ {S}_{{D}_{2}} \vert ( {S}_{{D}_{1}} ) ]} \cdot [ W \vert {S}_{{D}_{1}} ] ,$$

where the latter term is the base prediction and the former two terms are cross-prediction updates.

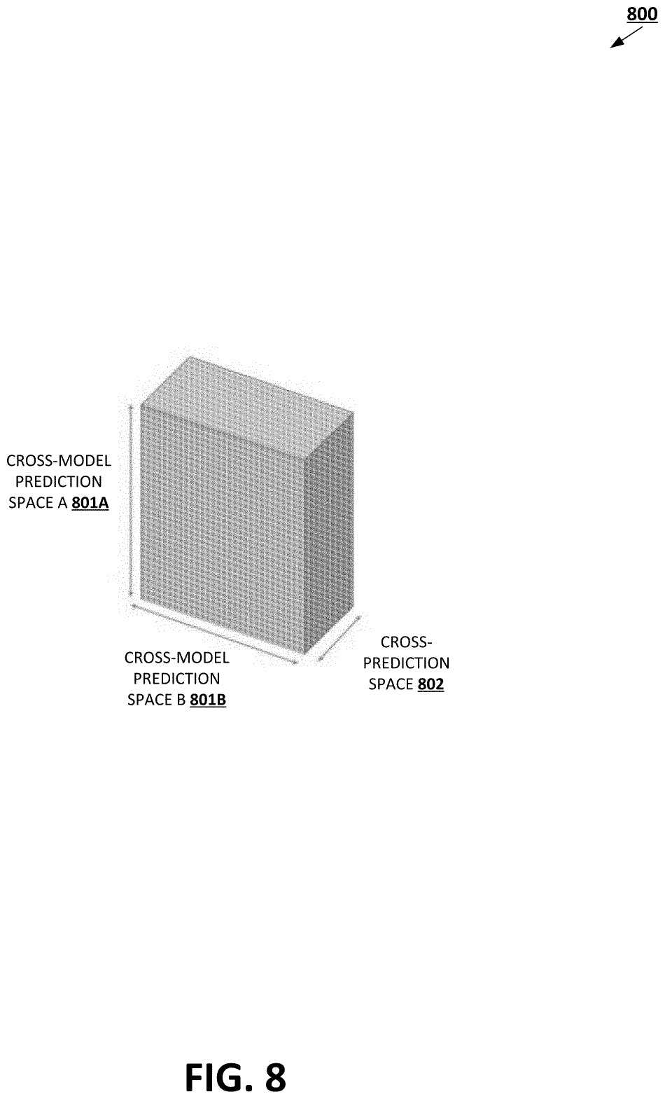

In some embodiments, the cross-model predictions 402 and the cross-prediction updates are determined based on a cross-prediction distribution, such as the cross-prediction distribution 800 of FIG. 8. The cross-prediction distribution 800 is associated with two cross-model predictions, i.e., a cross-model prediction A whose range is represented by the cross-model prediction space A 801A and a cross-model prediction B whose range is represented by the cross-model prediction space B 801B. The cross-prediction distribution 800 also includes a third dimension associated with the cross-prediction space 802, which indicates a cross-prediction for each combination of a particular value for the cross-model prediction A and a particular value for the cross-model prediction B. In some embodiments, a cross-prediction distribution such as the cross-prediction distribution 800 is stored on the storage subsystem 108 as part of the cross-prediction configuration data 123.

### Cross-Prediction Visual Representations

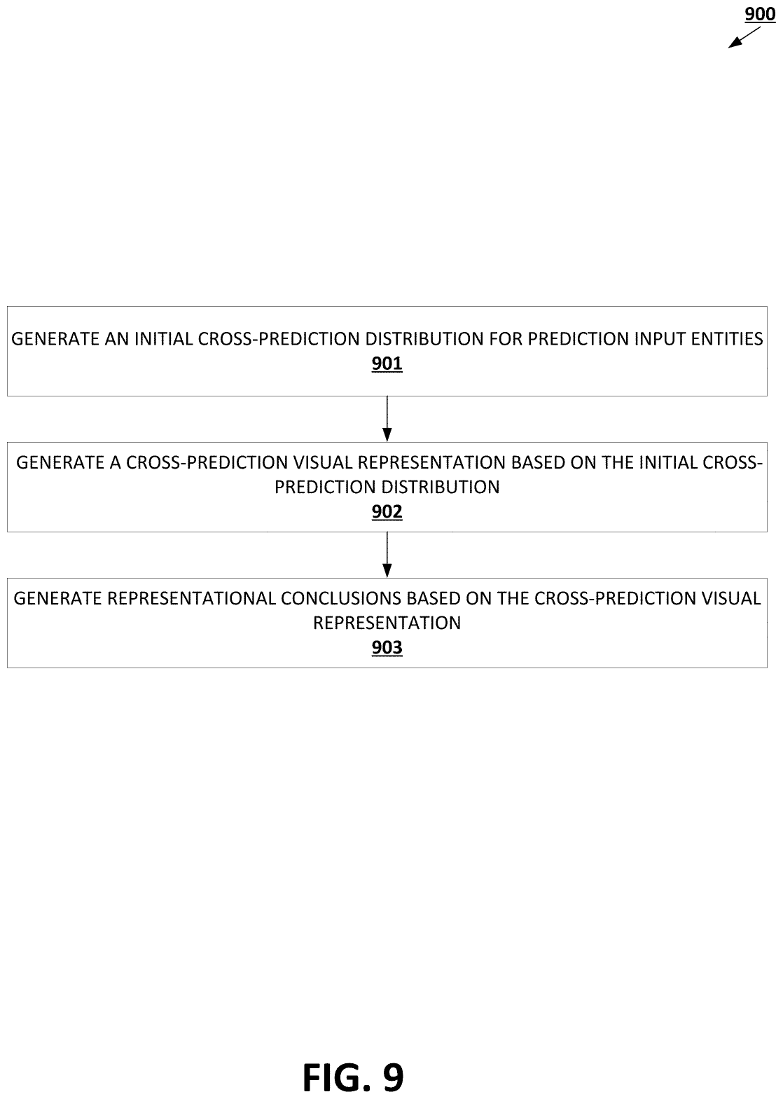

FIG. 9 is a flowchart diagram of an example process 900 for generating representational conclusions based on cross-prediction visual representations. Via the various steps/operations of process 900, a system of one or more computers can generate visual representations that are indicative of relationships between various predictions for various predictive tasks and utilize the noted visual representations to derive important insights about underlying cross-prediction distributions. The process 900 will now be described with reference to the predictive data analysis computing entity 106 of FIG. 1.

The process 900 begins at step/operation 901 when the predictive data analysis computing entity 106 generates an initial cross-prediction distribution for two or more prediction input entities. In some embodiments, the predictive data analysis computing entity 106 identifies the two or more prediction input entities (e.g., two or more patients) and obtains, for each prediction input entity, one or more cross-predictions, where the one or more cross-predictions for each prediction input entity relate to one or more predictive tasks associated with the initial cross-prediction distribution. For example, for each patient, the predictive data analysis computing entity 106 may generate a cross-prediction characterizing a cancer multi-morbidity prediction for the patient, an Alzheimer's disease multi-morbidity prediction for the patient, a Crone's disease multi-morbidity prediction for the patient, a cancer-plus-Alzheimer's-disease multi-morbidity prediction for the patient, a cancer-minus-Alzheimer's-disease multi-morbidity prediction for the patient, etc. In some embodiments, the initial cross-prediction distribution is characterized by a cross-prediction distribution space, where the cross-prediction distribution space may be an n-dimensional space and n may be equal to a number of cross-distributions associated with the cross-prediction distribution. In some embodiments, a particular disease may be associated with two or more prediction tasks. For example, cancer may be associated with a cancer-presence prediction, a cancer-absence prediction, a cancer-and-Alzheimer's disease prediction, a cancer-but-not-Alzheimer's disease prediction, etc.

At step/operation 902, the predictive data analysis computing entity 106 generates a cross-prediction visual representation based on the initial cross-prediction distribution space generated in step/operation 902. In some embodiments, the predictive data analysis computing entity 106 projects the initial cross-prediction distribution into a cross-prediction representation space to generate an updated cross-prediction distribution having a cross-prediction representation space, where the cross-prediction representation space may be an m-dimensional space and m may be lower than dimensions of the cross-prediction distribution space associated with the initial cross-prediction distribution space. In some embodiments, to project the initial cross-prediction distribution into the cross-prediction representation space, the predictive data analysis computing entity 106 performs dimensionality reduction. In some embodiments, the predictive data analysis computing entity 106 generates the cross-prediction visual representation based on the updated cross-prediction distribution.

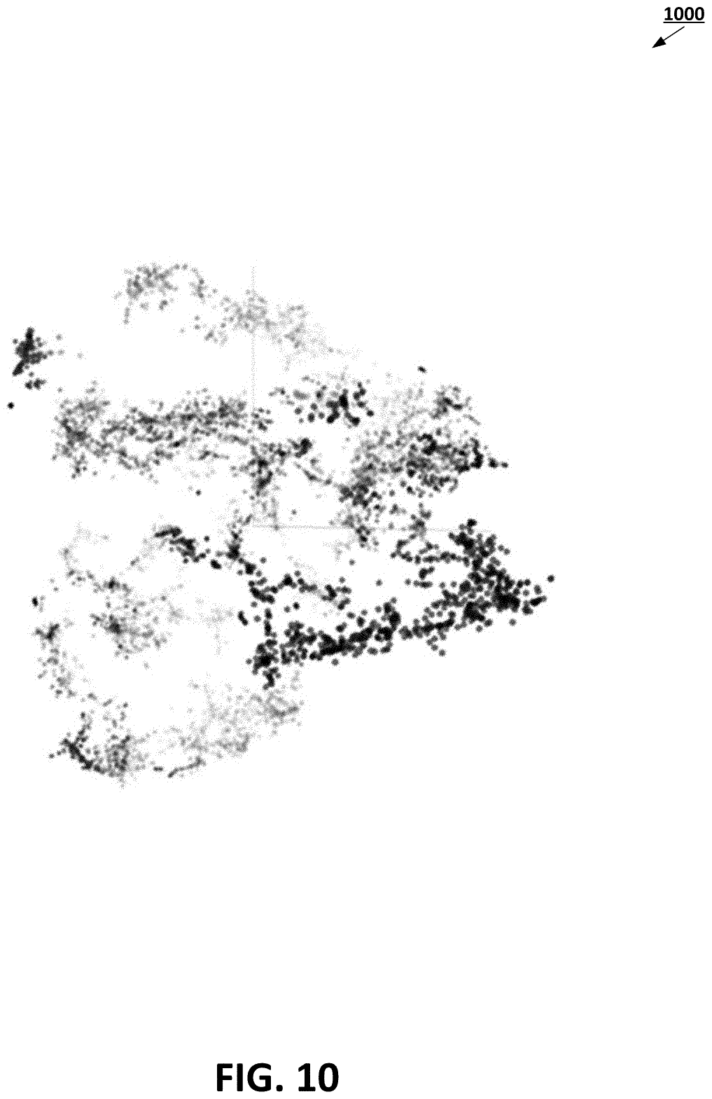

FIG. 10 provides an operational example of a cross-prediction visual representation 1000. The example cross-prediction visual representation 1000 is associated with a cross-prediction representation space having four cross-prediction representation dimensions, i.e., three geometric cross-prediction representation dimensions (i.e., an x-dimension, a y-dimension, and a z-dimension) as well as a cross-prediction representation dimension identified by the color distinctions. The four cross-prediction representation dimensions present a measure of cross-predictive distance between various prediction input entities. In some embodiments, each point in the example cross-prediction visual representation 1000 may correspond to a patient, and the color of each point may indicate the predominant disease prediction for the corresponding patient. In some of those embodiments, the geometric distance between the points may indicate measure of cross-predictive distances between patients having different predominant disease predictions. For example, the cross-prediction visual representation 1000 may indicate multi-morbidity similarities between malaria patients and cancer patients.

At step/operation 903, the predictive data analysis computing entity 106 generates one or more representational conclusions based on the cross-prediction visual representation generated in step/operation 902. In some embodiments, the predictive data analysis computing entity 106 generates one or more representational metrics based on the cross-prediction visual representation and generates the representational conclusions based on the one or more representational metrics. In some embodiments, at least some of the representational metrics are each determined based on a difference between at least two values identified by the cross-prediction visual representation, for example a difference between geometric coordinates for two or more prediction input entities represented by the cross-prediction visual representation. In some embodiments, at least some of the representational metrics describe the updated cross-prediction distribution associated with the cross-prediction visual representation. In some embodiments, at least some of the representational metrics are determined using one or more computational geometry routines. In some embodiments, at least some of the representational conclusions describe multi-morbidity conclusions across a population of patients.

In some embodiments, the predictive data analysis computing entity 106 generates one or more reports and/or performs one or more actions based on the representational conclusions. For example, given a representational conclusion that cancer patients have a higher propensity for another disease, the predictive data analysis computing entity 106 may schedule tests and/or visitations for cancer patients intended to determine whether the cancer patients have the other disease. As another example, given a representational conclusion that cancer patients have a higher propensity for another disease, the predictive data analysis computing entity 106 may generate alerts for physicians of the cancer patients noting the discovered relationship. As a further example, the predictive data analysis computing entity 106 may generate multi-morbidity reports indicating discoveries about relationships between various diseases and conditions, such as reports associated with individual patients and/or reports for entire segments of patients.

### V. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a cross-prediction for a particular predictive task of a plurality of predictive tasks, wherein the plurality of predictive tasks comprises the particular predictive task and one or more related predictive tasks, the computer-implemented method comprising:
obtaining, for each predictive task of the plurality of predictive tasks, a plurality of per-model inferences, wherein each per-model inference of the plurality of per-model inferences associated with a predictive task of the plurality of predictive tasks is determined based at least in part on a predictive model of a plurality of predictive models for the per-model inference;
generating, for each predictive task of the plurality of predictive tasks, a cross-model prediction based at least in part on the plurality of per-model inferences for the predictive task; and
generating, based at least in part on each cross-model prediction associated with a predictive task of the plurality of predictive tasks, a cross-prediction for the particular predictive task, wherein: (i) determining the cross-prediction comprises applying one or more probabilistic updates to the cross-model prediction for the particular predictive task and (ii) each probabilistic update of the one or more probabilistic updates is determined based at least in part on the cross-model prediction for a related predictive task of the one or more related predictive tasks.

2. The computer-implemented method of claim 1, further comprising:
determining each per-model inference associated with a predictive task based at least in part on the predictive model for the per-model inference by processing a predictive input for the predictive model in accordance with the predictive model.

3. The computer-implemented method of claim 1, wherein each predictive task of the plurality of predictive tasks is related to a disease prediction task of a plurality of disease prediction tasks.

4. The computer-implemented method of claim 1, wherein generating each cross-model prediction for a predictive task of the plurality of predictive tasks is performed based on a cross-model ensemble model for the predictive task.

5. The computer-implemented method of claim 1, wherein:
the plurality of predictive tasks are associated with a cross-prediction order,
the cross-prediction order defines a cross-prediction degree for each predictive task of the plurality of predictive tasks,
each probabilistic update of the one or more probabilistic updates is associated with a related predictive task of the one or more related predictive tasks,
each probabilistic update of the one or more probabilistic updates is associated with one or more lower-degree predictive tasks of the plurality of predictive tasks whose respective cross-prediction degrees are lower than the cross-prediction degree for the related predictive task associated with the probabilistic update, and
each probabilistic update relates a partial prediction based at least in part on cross-model prediction scores for the one or more lower-degree predictive tasks to the cross-prediction.

6. The computer-implemented method of claim 1, further comprising:
generating a related cross-prediction for each related predictive task of the one or more related predictive tasks; and
generating a cross-prediction distribution for the plurality of predictive tasks based at least in part on the cross-prediction for the first prediction task and each related cross-prediction for a related predictive task of the one or more related predictive tasks.

7. The computer-implemented method of claim 6, further comprising:
generating a cross-prediction visual representation based on the cross-prediction distribution.

8. The computer-implemented method of claim 7, wherein:
the cross-prediction visual representation is associated with a representation space; and
generating the cross-prediction visual representation comprises projecting the cross-prediction distribution into the representation space.

9. The computer-implemented method of claim 7, wherein:
the cross-prediction distribution is associated with a distribution space; and
the distribution space has more dimensions than the representation space.

10. The computer-implemented method of claim 7, further comprising:
generating one or more representational metrics for the cross-prediction representation; and
generating one or more representational conclusions based at least in part on the one or more representational metrics.

11. An apparatus comprising at least one processor and at least one non-transitory memory comprising program code, wherein the at least one non-transitory memory and the program code are configured to, with the at least one processor, cause the apparatus to perform a method for generating a cross-prediction for a particular predictive task of a plurality of predictive tasks, wherein the plurality of predictive tasks comprises the particular predictive task and one or more related predictive tasks, and wherein the method comprise:
obtaining, for each predictive task of the plurality of predictive tasks, a plurality of per-model inferences, wherein each per-model inference of the plurality of per-model inferences associated with a predictive task of the plurality of predictive tasks is determined based at least in part on a predictive model of a plurality of predictive models for the per-model inference;
generating, for each predictive task of the plurality of predictive tasks, a cross-model prediction based at least in part on the plurality of per-model inferences for the predictive task; and
generating, based at least in part on each cross-model prediction associated with a predictive task of the plurality of predictive tasks, a cross-prediction for the particular predictive task, wherein: (i) determining the cross-prediction comprises applying one or more probabilistic updates to the cross-model prediction for the particular predictive task and (ii) each probabilistic update of the one or more probabilistic updates is determined based at least in part on the cross-model prediction for a related predictive task of the one or more related predictive tasks.

12. The apparatus of claim 11, the method further comprising:
determining each per-model inference associated with a predictive task based at least in part on the predictive model for the per-model inference by processing a predictive input for the predictive model in accordance with the predictive model.

13. The apparatus of claim 11, wherein each predictive task of the plurality of predictive tasks is related to a disease prediction task of a plurality of disease prediction tasks.

14. The apparatus of claim 11, wherein generating each cross-model prediction for a predictive task of the plurality of predictive tasks is performed based on a cross-model ensemble model for the predictive task.

15. The apparatus of claim 11, wherein:
the plurality of predictive tasks are associated with a cross-prediction order,
the cross-prediction order defines a cross-prediction degree for each predictive task of the plurality of predictive tasks,
each probabilistic update of the one or more probabilistic updates is associated with a related predictive task of the one or more related predictive tasks,
each probabilistic update of the one or more probabilistic updates is associated with one or more lower-degree predictive tasks of the plurality of predictive tasks whose respective cross-prediction degrees are lower than the cross-prediction degree for the related predictive task associated with the probabilistic update, and
each probabilistic update relates a partial prediction based at least in part on cross-model prediction scores for the one or more lower-degree predictive tasks to the cross-prediction.

16. The apparatus of claim 11, the method further comprising:
generating a related cross-prediction for each related predictive task of the one or more related predictive tasks; and
generating a cross-prediction distribution for the plurality of predictive tasks based at least in part on the cross-prediction for the first prediction task and each related cross-prediction for a related predictive task of the one or more related predictive tasks.

17. A non-transitory computer storage medium comprising instructions configured to cause one or more processors to at least at least perform a method for generating a cross-prediction for a particular predictive task of a plurality of predictive tasks, wherein the plurality of predictive tasks comprises the particular predictive task and one or more related predictive tasks, and wherein the method comprise:
obtaining, for each predictive task of the plurality of predictive tasks, a plurality of per-model inferences, wherein each per-model inference of the plurality of per-model inferences associated with a predictive task of the plurality of predictive tasks is determined based at least in part on a predictive model of a plurality of predictive models for the per-model inference;
generating, for each predictive task of the plurality of predictive tasks, a cross-model prediction based at least in part on the plurality of per-model inferences for the predictive task; and
generating, based at least in part on each cross-model prediction associated with a predictive task of the plurality of predictive tasks, a cross-prediction for the particular predictive task, wherein: (i) determining the cross-prediction comprises applying one or more probabilistic updates to the cross-model prediction for the particular predictive task and (ii) each probabilistic update of the one or more probabilistic updates is determined based at least in part on the cross-model prediction for a related predictive task of the one or more related predictive tasks.

18. The non-transitory computer storage medium of claim 17, the method further comprising:
determining each per-model inference associated with a predictive task based at least in part on the predictive model for the per-model inference by processing a predictive input for the predictive model in accordance with the predictive model.

19. The non-transitory computer storage medium of claim 17, wherein each predictive task of the plurality of predictive tasks is related to a disease prediction task of a plurality of disease prediction tasks.

20. The non-transitory computer storage medium of claim 17, wherein generating each cross-model prediction for a predictive task of the plurality of predictive tasks is performed based on a cross-model ensemble model for the predictive task.
